(19) United States
(12) Patent Application Publication
(10) Pub. No.: US 2003/0023474 A1
(43) Pub. Date: Jan. 30, 2003

(54) Remote job performance system

(76) Inventor: Robin Helweg-Larsen, Chapel Hill, NC (US)

Correspondence Address: COATS & BENNETT, PLLC, P O BOX 5, RALEIGH, NC, 27602, US

(21) Appl. No.: 09/912,858

(22) Filed: Jul. 25, 2001

(51) Int. Cl. G06F 17/60

(52) U.S. Cl. 705/9

(57) ABSTRACT

A system for incentivizing the performance of labor remotely from a job site comprises a network of computers through which a laborer may perform the labor. A service provider collects a fee from potential laborers and then provides those laborers with a game like environment to perform work for employers who in turn pay the laborers. Alternatively, an employer may pay the service provider to list the jobs and work with the laborers.

### BACKGROUND OF THE INVENTION

1. Field of the Invention

The present invention relates to a system that enables and incentivizes the performance of certain tasks from a remote location.

2. Description of the Related Art

With the initial explosion of the Internet a thing of the past, the new boundary that people are pushing is connection speed. The advent of high-speed network access has opened many doors for more people than ever before. Numerous households are cable equipped. DSL and satellite communication serve still more. A few have T1 or even T3 lines serving them, although such lines are typically used by businesses rather than individuals.

Coupled to this increase in connection rate is the ability to send and receive more content over these high bandwidth links. Streaming video is approaching a normal video signal for people with cable modems or DSL modems. Additionally, content receivers are now also having access to high-speed content provision links. This high-speed duplex communication system will only expand in the future.

Also interesting for the purposes of the present invention is a currently misallocated work force. Some of the most populous countries are plagued with idle hands in the face of too few jobs. Other countries, in which jobs are plentiful, are experiencing declining birth rates and tight labor markets. This problem exists both at the macroscopic international level, and within even a single state as some cities have higher employment rates than others, but residents refuse to move to where the jobs are.

Of further interest is a rising generation of potential workers that have essentially been raised on video games. Declining are the days of families sitting around the MONOPOLY board playing a face-to-face game of skill and chance. This idyllic sitting has been replaced with endless hours of DOOM and QUAKE, or console games and the like. These future laborers think in terms of achieving the next level or power up and its concurrent rewards. High ranking positions or powerful characters are coveted and a lively market exists for high level second hand characters on games like EVERQUEST, ASHERON'S CALL, ULTIMA ONLINE, and the like, proving the point.

A convergence of these three factors gave birth to the present invention.

### SUMMARY OF THE INVENTION

A system for the remote performance of a job comprises linking individuals to a service provider and possibly training them to perform certain tasks. The laborer may pay a fee to be in the pool of candidates for the service provider. Employers may contact the service provider with jobs available and requirements for a candidate to fill that job. The service provider evaluates the laborers in its pool of available laborers and makes a match.

The laborer then uses a network connection to perform the task for the employer. The employer pays the laborer for the work and all three parties reap the financial benefit of the arrangement. As the laborer works or trains more, the laborer may pick up new skill sets. The new skill sets in turn may allow the laborer to be qualified for a broader range of jobs including higher paying jobs or jobs with more stringent requirements from the employer. Levels, awards, ranks, and the like may be used to incentivize the labor of the laborer. By treating it as a game, the service provider may be more likely to attract laborers from the pool of gamer that are entering the workplace.

### BRIEF DESCRIPTION OF THE DRAWINGS

FIG. 1 illustrates an exemplary system such as may be used with the present invention;

FIG. 2 illustrates an alternate embodiment of a system that may be used with the present invention;

FIG. 3 illustrates an exemplary work environment for a laborer using the present invention;

FIG. 4 illustrates a flow chart of an exemplary process by which a service provider may attract employers to use the present invention; and

FIG. 5 illustrates a flow chart of an exemplary process by which a service provider may attract laborers to use the present invention.

### DETAILED DESCRIPTION

The present invention is particularly contemplated as being a web-based system that pairs laborers to employers for the provision of mutually satisfactory services. The individual, company, or other entity that provides the services herein described shall be referred to as the “service provider.” An employer, for the purposes of the present invention is an entity that has a job that must be done. A laborer is someone who can perform that job. For full understanding of the present invention, reference is made to the accompanying drawings.

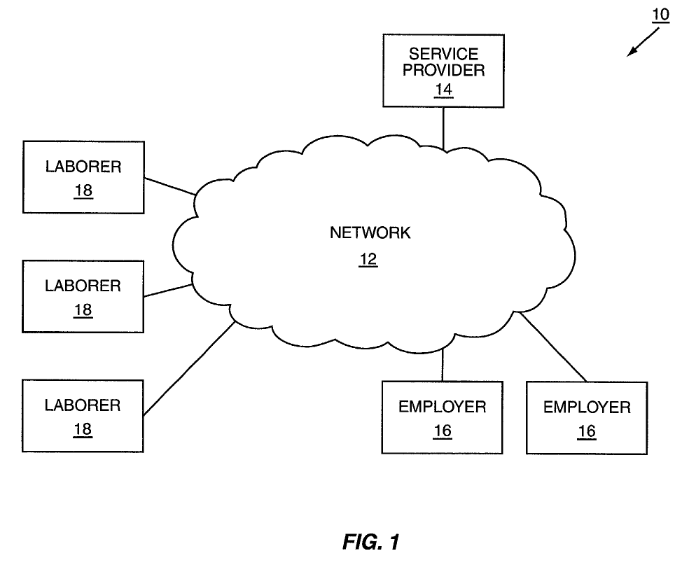

Specifically, FIG. 1 illustrates, in a block diagram format, a system 10 that may be used by the present invention. System 10 comprises a network 12 connected to a number of computers. Specifically, a service provider computer 14 may be connected to the network 12 along with employer computers 16 and laborer computers 18.

As used herein, the term “computer” comprises a number of data processing devices including servers, personal computers, mobile terminals such as cellular phones, lap tops, personal digital assistants, and the like. Further, the term computer also comprises a data collation station such as a video controller that takes one or more video feeds and passes them to a network 12.

Network 12 may comprise a number of related sub-networks, each with its own medium of communication. In an exemplary embodiment, the network 12 comprises the Internet and is comprised of sub-networks such as the Public Standard Telephone Network (PSTN), the Public Land Mobile Network (PLMN), cable networks, satellite networks, and the like. Even within these sub-networks, further sub-sub-networks may exist, for example, Internet Service Providers such as BELLSOUTH.NET, AOL, and the like may have their own proprietary networks through which certain consumers may reach the Internet or network 12. Each sub-network may be comprised of wire based or wireless communication links. For the purposes of the present invention, wire based communication links include optical fiber communication links.

Service provider computer 14 may be a personal computer with a microprocessor therein, or may be a dedicated network server or the like as needed or desired and may include memory and software as is well understood. The software enables the operation of the service provider computer 14 as well as implements certain portions of the present invention as is explained in greater detail below. The memory for service provider computer 14 may be a hard drive, flash memory, EEPROM, CD-ROM, optical CD, floppy disk, DVD-ROM, magnetic tape, or other form of computer memory as is well understood in the field of computers. The software may be written in any appropriate code as needed or desired.

While the service provider computer 14 could be a centralized computer at one physical location, those skilled in the art will appreciate that the service provider computer 14 could use other architectures to accomplish the same functionality. In another embodiment, the service provider computer 14 could be a distributed system with multiple computer systems, each of them comparable to the computer described above, and located at one physical location, linked together through a local area network (LAN). Each of the computer systems performs part of the tasks of the present invention. These tasks may be run in parallel or in series as needed or desired by the system. In yet another embodiment, the service provider computer 14 could be a distributed system with multiple computer systems scattered across a number of physical locations, but linked together through a wide area network (WAN). Each of the computer systems may also perform only one part of the tasks of a centralized host computer system.

It is specifically contemplated that the service provider computer 14 may be connected to the network 12 at all times and therefore should be adapted to have a fail safe and hot-swappable structure. This will allow continued operation even in the event of isolated failures within the system. Additionally, the software may be backed-up regularly, as is well known in the industry, to recover in the event of a catastrophic failure.

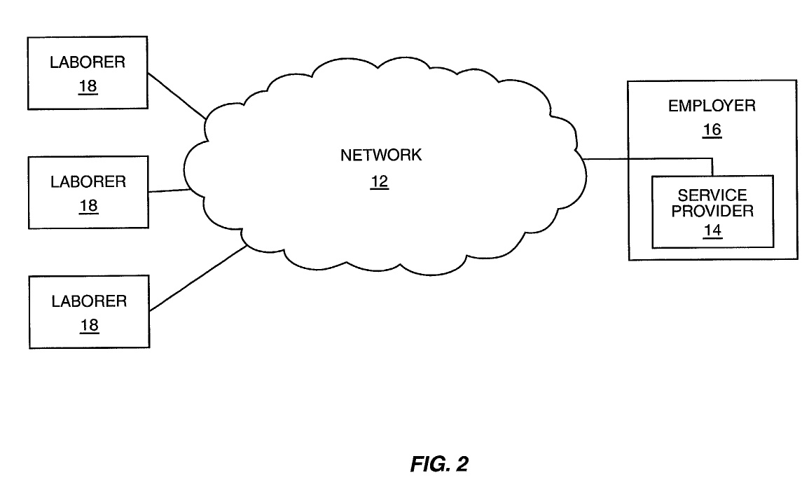

An alternate embodiment is seen in FIG. 2, wherein the service provider computer 14 and the services provided thereby are subsumed within an employer, and specifically within an employer computer 16. This merely reflects the fact that the services of the present invention need not be provided by a third party such as a distinct service provider, but may be so implemented if desired.

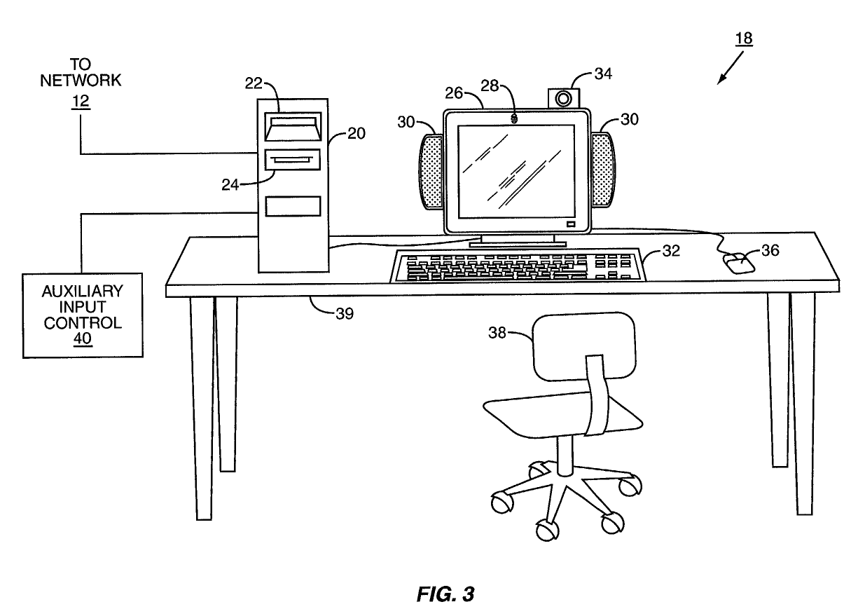

Laborer computer 18 is more explicitly illustrated in FIG. 3. Specifically, laborer computer 18 may comprise a tower unit 20 with floppy drive 22 and hard drive 24. While not shown, tower unit 20 may comprise a microprocessor such as a PENTIUM IV therewithin. Other microprocessors are also possible. Tower unit 20 may be connected to a monitor 26. Monitor 26 may comprise a microphone 28 and speakers 30. Input devices, such as a keyboard 32, a camera 34, and a mouse 36 may further be connected to the tower unit 20. A chair 38 and a table 39 may be provided as needed or desired. Still further, an auxiliary, specialized control input unit 40 may also be connected to the tower unit 20. Auxiliary, specialized control input unit 40 will be described in greater detail below, but essentially comprises any non standard input that a laborer would need to complete a job. These will vary depending on the job performed and the resources of the laborer to purchase such specialized hardware. While not shown, other conventional input devices may also be connected to the tower unit 20 such as a joystick, paddles, a stylus, roller ball, track pad, scanner, virtual reality glove, or the like. Other output devices may also be present such as a printer, a plotter, virtual reality helmet, or the like.

Employer computer 16 may comprise sensors and other input and output devices that enable information about a particular workspace to be conveyed to the laborer.

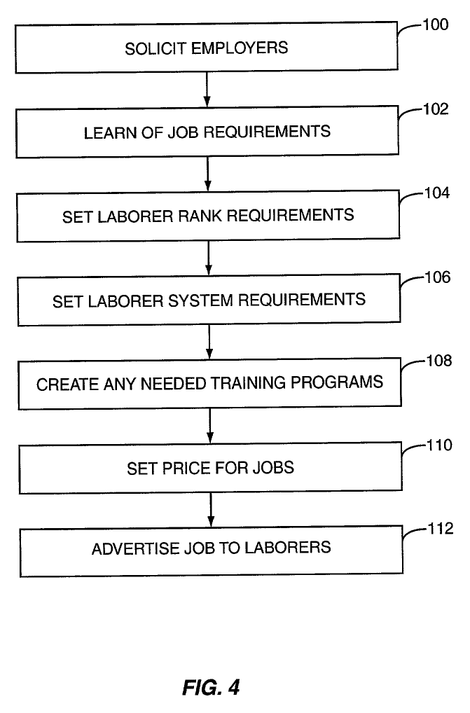

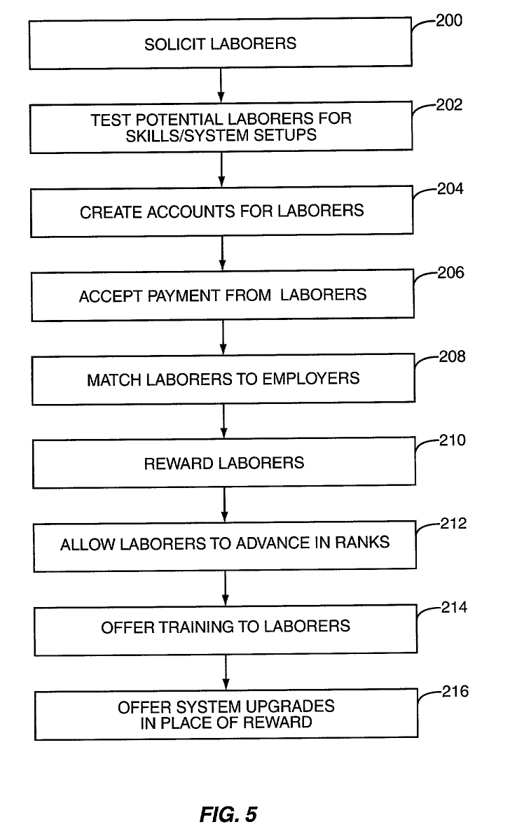

Against this background of hardware components, the functionality of the present invention is better explicated. The present invention is designed to match laborers with employers so that the laborers may perform jobs for the employers from a location remote from the employer, while providing financial recompense to the laborer and the service provider. Both of the processes of FIGS. 4 and 5 may be executed concurrently or one after the other, in either order, but for optimal income to the service provider, both a pool of laborers and at least one employer should be available concurrently so as to perform the matching.

FIG. 4 illustrates a process by which the service provider may prepare employers. Specifically, the service provider solicits employers to use the service (block 100). This solicitation may be done by advertisements (print, video and/or audio), mail, email, personal presentations, fliers, or the like. These communications may be targeted to employers that are known to need employees or that are known to have jobs that could be performed remotely. Alternatively, these communications could be cold calls or blind mailings if desired. In these communications, the virtues and wonders of the services provided may be extolled and presented in a flashy, eye catching manner as needed or desired. POWER POINT presentations or the like may be used where appropriate, but in short, this step involves getting the attention of potential employers and enticing them to use the service of the present invention.

Once an employer has committed to using the services of the service provider, the service provider learns of the job requirements that the employer has for the jobs available (block 102). This may be done by inspecting the premises where the job is normally performed, a job description write up, or other manner.

Based on the job requirements, the service provider may set the laborer rank requirements (block 104). For simple, repetitive jobs, the rank requirements may be low. For example, monitoring a stadium parking lot for vandalism through a series of cameras does not require special sorts of training and may be an entry-level job. However, monitoring a parking lot of an embassy may require a proven degree of reliability and might warrant a higher-ranking laborer to fill the spot. Likewise, some jobs may require certain skill sets that only higher-ranking laborers have.

Further, based on the job requirements, the service provider may set the laborer system requirements (block 106). This is a minimum set up for laborer computer 18 that the laborer must have to perform the job adequately. For example, the aforementioned parking lot monitoring job may require a high speed connection, a certain set of video processing software and a plurality of monitors 26. Another job may require high levels of data crunching performed by the laborer computer 18 and thus require a large memory and/or powerful microprocessor or math coprocessor. Any special item that is required to perform the job would be detailed here and generally fall under the label auxiliary specialized control unit 40.

It is possible when a job is first created that no laborer presently in the service provider's pool of laborers is qualified to perform the job, and thus training may be required. The service provider may create any needed training programs (block 108). These are preferably online training programs, but may also be correspondence, classroom based, or in person training programs as needed or desired.

While not illustrated within the flow chart, the service provider may create an account for the employer and/or the specific job contemplated. Such an account may include all the relevant data extracted about the job, how the employer wishes to pay, and other information related to the job and/or employer. Such an account may make it easier for a database structure to perform operations relating to matching as described below.

In one embodiment, the service provider may charge a fee to the employer for listing the job. If this is true, the service provider may set the price for the job (block 110). If the employer has not already decided on a pay rate for the job, this may be set too. Further, in one embodiment, the service provider charges laborers for jobs found for the laborers. Thus, a price must be set that the laborers must pay to be eligible to take a particular job. All of these, for the purposes of the present invention are to be construed as falling within setting a price for the job.

The service provider may also advertise the job to the laborers (block 112). This may be done by email notification, listing on a web page, mail or phone notification, or other technique as needed or desired. Note that for the embodiment illustrated in FIG. 2, the initial steps of this process are not necessary, as the employer is the service provider and presumably knows the requirements for the job. Further note that the steps need not occur in the sequence listed. While this arrangement has some logic to it, other sequences are still within the scope of the present invention.

The other side of the business of the present invention is illustrated in FIG. 5. Initially, the service provider solicits laborers (block 200). This solicitation may be comparable to that described above with reference to the employers. However, other alternatives are also available in this context. For example, job fairs at high schools and college campuses may allow captive audiences to be targeted. Likewise, unemployment offices may be given fliers or the like that an individual may see or take during the process of securing their unemployment benefits. Additionally, government programs designed to get people off welfare may be provided with promotional literature so that such agencies may push the soon to be benefit bereft individuals toward the service provider and possible employment.

After a potential laborer has expressed interest in using the services of the present invention, the service provider may test the potential laborer for skills and system setups (block 202). Skill aptitude tests are conventional and in some instances may be administered remotely. Testing the system of the potential laborer may comprise a visual inspection of laborer computer 18 and its peripherals, a remote diagnostic test, evaluation of a written submission from the potential laborer, or the like as needed or desired. The test may be made by the service provider or the employer, and in some instances, employers may insist that they be allowed to verify test results to make sure that a given laborer is capable of performing a job.

The service provider may create an account for the potential laborer (block 204). Included in this account would be any skills that the laborer is known to possess, the limitations and/or capabilities of the laborer computer 18, a name, an address, any payment information provided by the laborer, any account information about how the laborer wishes to be paid by employers, and other information as needed or desired.

When a laborer wants to work, the laborer pays the service provider for the opportunity to work. The service provider accepts the payment from the laborer (block 206). This payment may be done via cash, credit card, check, direct withdrawal/deposit, or the like as needed or desired. As noted above, this information may be in the laborers account, and the entire process automated by software.

The service provider matches the laborers to employers (block 208). This may be done by comparing the skills of the laborer to the skills required by the job. Alternatively, certain ranks or levels of laborers may, by definition of achieving that rank or level, have certain skills. Thus, comparing a rank may also be done. Still further, system capabilities are checked to make sure that a particular laborer computer 18 has the capabilities required to perform the job. If everything can be matched, the service provider informs the laborer that they have a job and the employer that they have a laborer.

The laborers will perform the jobs to which they have been matched. The employers will pay the laborers either directly, or through the service provider as arranged. In addition to this financial reward, the service provider may reward the laborer for jobs completed (block 210). These rewards may be in terms of experience points, skill rank improvements, authority improvements, or the like. Rewards may be recorded in the laborer's account.

With enough experience points and/or other rewards, the service provider may allow the laborers to advance in ranks (block 212). This may entitle the laborer a higher percentage of the pay from the employer if the pay is funneled through the service provider, or, alternatively, the rank advancement may entitle the laborer to a higher base pay rate, or as yet another alternative, the rank advancement may make the laborer eligible for more rewarding and/or challenging tasks. Rank advancement may be recorded in the laborer's account.

As another feature, the service provider may offer training to laborers (block 214) so that the laborers may become qualified for different tasks. In a preferred embodiment, the laborers pay for this training, but this is not required. Again, as noted above, this training may be online, by correspondence, in a classroom, or the like as needed or desired. Any training completed may be recorded in the laborer's account.

It is further possible that instead of a reward, the service provider may offer system upgrades, hardware, software, or the like to allow the laborer to improve their laborer computer 18. This may also be done in place of pay as a payroll deduction or the like. Again, note that the precise order of events need not be exactly as laid out in the flow chart, but may be rearranged as needed or desired.

While not shown explicitly as a flow chart, the actual performance of a job by a laborer is as follows. After receiving notification of being eligible to perform a job, the laborer pays the required fee and makes an appropriate connection to the employer computer 16 from the laborer computer 18. This may be done directly through the network 12 or through the service provider computer 14 as needed or desired. Encryption or other security measures may be used if the job is of a sensitive nature to protect the transmissions to and from the employer computer 16. After the connection is made, the laborer uses the laborer computer 18 to perform the task required.

For example, if the job was to monitor security cameras in a parking lot, the laborer receives one or more streaming video feeds from the employer computer 14 and views them on one or more monitors 26. In the event that an abnormality is detected, the laborer generates an alarm which summons the police or other security force to investigate the parking lot. While not glamorous, such jobs pave the way for jobs requiring a higher rank.

This system is also well suited for use where a laborer may control operations via a keyboard or other device. Remote material handling is also possible through the use of a virtual reality glove or the like that controls a robot hand. As the laborer manipulates his hand in a virtual reality environment, the robot hand mimics the actions of the laborer and tasks may be completed such as mixing chemical reagents or the like. Exemplary uses particularly contemplated include: monitoring, such as hospital wards, prison environments, warehouses, factory production lines, retail shopping aisles, parking lots, customer lines where extra registers can be opened (ticket offices for sports, movies, theme parks, banks, supermarkets, retail warehouses and the like), power generating stations, laboratories, airport facilities, automobile traffic, and the like. Likewise, controlling and regulating doors, gates, barriers, traffic flow of pedestrians, temperature, pressure, fuel, environmental conditions may be possible. People desiring to pass through a barrier present identification to a camera that sends a signal to the laborer. The laborer actuates a command that allows the individual through the barrier. Also contemplated is controlling and modifying automated systems of production, distribution, storage, repair, and cleaning. Managing work crews, networked systems, and distance communications are also possible as is operating machinery or equipment.

Service providers may provide add on features, optionally at an additional cost. One such feature is an alarm that is generated for a laborer when a particularly choice job for which the laborer is qualified becomes available. For example, an audible tone may be generated on the laborer computer 18 when a high paying job is available.

In addition to advancing in ranks, it is possible to track laborer failures. Thus, if a laborer proved unreliable, caused accidents, or otherwise proved unsuitable for certain tasks despite apparently having the prerequisite skills, a note to that effect may be placed in the laborer's account and the laborer in question be denied similar sorts of jobs in the future. Other penalties could be invoked, such as a financial penalty, loss of rank, or even civil legal proceedings.

In one embodiment, laborers may not have access to a laborer computer 18 of their own. To allow such laborers to still perform work, the service provider may create satellite offices equipped with laborer computers 18 that the laborers may “rent” so that they may work. This may be somewhat akin to an arcade in some ways in that a laborer arrives, pays to use a laborer computer 1 8, and then logs into their job, which they treat as a game. The laborer pays again to do the job, but is likewise paid by the employer for the work performed. This embodiment requires more resources on the part of the service provider, but still falls within the scope of the present invention.

The present invention may, of course, be carried out in other specific ways than those herein set forth without departing from the scope and the essential characteristics of the invention. The present embodiments are therefore to be construed in all aspects as illustrative and not restrictive and all changes coming within the meaning and equivalency range of the appended claims are intended to be embraced therein.

What is claimed is:

1. A method of promoting business, comprising:
generating a pool of laborers;
associating an employer with one or more jobs to be performed; and
facilitating at least one of the laborers in said pool of laborers to work for said employer remotely over a network.

2. The method of claim 1 wherein said laborers pay a service provider for working for said employer.

3. The method of claim 1 wherein said employer pays said laborer.

4. The method of claim 1 wherein laborers advance in rank as they work for said employer.

5. The method of claim 4 wherein advancing in rank allows laborers to qualify for different jobs with different requirements.

6. The method of claim 1 further comprising training at least one laborer from said pool of laborers, said training qualifying said laborer to perform a job for the employer.

7. The method of claim 1 wherein facilitating at least one of the laborers in said pool of laborers to work for said employer remotely over a network comprises facilitating at least one of the laborers in said pool of laborers to work for said employer remotely over the Internet.

8. The method of claim 1 further comprising generating an alert for at least one of said laborers in said pool of laborers when a particular job is available.

9. The method of claim 1 wherein employers pay a service provider to be listed on a service provider that performs said facilitating.

10. A system for promoting business, comprising:
a laborer computer comprising input and output devices;
an employer computer comprising sensors relating to a job environment; and
a network connection between said laborer computer and said employer computer;
wherein a laborer can use said laborer computer to work for an employer from a remote location, said laborer able to receive information from said employer computer about the job environment at the employer and able to send commands to said employer computer such that said commands may impact the job environment.

11. The system of claim 10 wherein said network connection is the Internet.

12. The system of claim 10 wherein said job environment comprises monitoring a facility.

13. The system of claim 10 wherein said job environment comprises monitoring a process.

14. A method of allowing laborers to perform jobs from a remote location, comprising:
establishing a service provider that evaluates the laborers for skills;
ensuring that the laborers have access to laborer computers of adequate processing power to perform certain jobs;
connecting some of said laborers to an employer over a network such that the laborers can communicate with the employer;
charging the laborers to be connected; and
advancing the laborers through ranks contingent upon successful completion of one or more jobs for the employer.

15. The method of claim 14 wherein establishing a service provider that evaluates laborers for skills comprises establishing a service provider within the employer.

16. The method of claim 14 further comprising receiving payment from the employer and passing at least a portion of the payment to the laborer in exchange for labor performed by the laborer for the employer.

17. The method of claim 14 further comprising allowing laborers that have advanced through one or more ranks to be connected to the employer for a job for which a laborer who has not advanced through one or more ranks is not eligible.

18. The method of claim 14 further comprising demoting a laborer for failing to perform a job adequately.

19. The method of claim 18 further comprising denying jobs to laborers on the basis of a demotion.

20. The method of claim 14 further comprising advancing the laborers through ranks contingent upon successful completion of training.
